(19) United States
(12) Patent Application Publication
(10) Pub. No.: US 2022/0358458 A1
(43) Pub. Date: Nov. 10, 2022

(54) SECURE BLOCKCHAIN SUPPLY MANAGEMENT SYSTEM

(71) Applicant: Gray Matters, Inc., Annapolis, MD (US)

(72) Inventors: Jeffrey Gerald, Annapolis, MD (US); Robert Schlicher, Annapolis, MD (US)

(73) Assignee: Gray Matters, Inc., Annapolis, MD (US)

(21) Appl. No.: 17/737,002

(22) Filed: May 4, 2022

Related U.S. Application Data
(60) Provisional application No. 63/183,744, filed on May 4, 2021.

(51) Int. Cl. G06Q 10/08; G06Q 20/40; H04L 9/00

(52) U.S. Cl. CPC G06Q 10/0835; G06Q 20/4016; H04L 9/50

(57) ABSTRACT

Techniques for a secure blockchain supply management system are disclosed. A blockchain node may load a contract to a blockchain rules engine and invoke a blockchain transaction associated with the contract document. The blockchain node may determine an ordered block of one or more other transactions. The blockchain node may provide the blockchain transaction associated with the contract document. In some cases, the blockchain node may authorize the blockchain transaction associated with the contract document based at least in part on one or more blockchain policies. Also, the blockchain node may install the blockchain transaction associated with the contract document.

### CROSS REFERENCE

The present Application for Patent claims the benefit the benefit of U.S. Provisional Patent Application No. 63/183,744 by Salomon et al., entitled “SECURE BLOCKCHAIN SUPPLY MANAGEMENT SYSTEM AND METHOD OF USE,” filed May 4, 2021, assigned to the assignee hereof, and expressly incorporated herein.

### FIELD OF TECHNOLOGY

The present disclosure relates generally to data processing, and more specifically to secure blockchain supply management system.

### BACKGROUND

A computing system may include a cloud platform (i.e., a computing platform for cloud computing) that may be employed by users to store, manage, and process data using a shared network of remote servers. Users may access the cloud platform using various user devices (e.g., desktop computers, laptops, smartphones, tablets, or other computing systems, etc.). A cloud service provider may provide various services in a computing system, and the services may be provided over a network, such as the Public Internet. Some service models may include infrastructure as a service (IaaS), platform as a service (PaaS), software as a service (SaaS), and network as a service (NaaS). Computing systems may be employed in certain data processing systems.

### BRIEF DESCRIPTION OF THE DRAWINGS

FIG. 1 illustrates an example of computing environment that supports blockchain supply chain management in accordance with aspects of the present disclosure system.

FIG. 2 illustrates an example of blockchain nodes in a blockchain database that supports secure blockchain supply management systems in accordance with aspects of the present disclosure.

FIG. 3 illustrates an example of blockchain nodes in a blockchain database that supports secure blockchain supply management systems in accordance with aspects of the present disclosure.

FIG. 4 illustrates an example of security in a cloud platform that supports secure blockchain supply management systems in accordance with aspects of the present disclosure.

FIG. 5 illustrates an example of authentication process that supports secure blockchain supply management systems in accordance with aspects of the present disclosure.

FIG. 6 illustrates an example of a smart contract workflow that supports secure blockchain supply management systems in accordance with aspects of the present disclosure.

FIG. 7 illustrates an example of event and trigger processing that supports secure blockchain supply management systems in accordance with aspects of the present disclosure.

FIG. 8 illustrates an example of an Internet of Things (IoT) system that supports secure blockchain supply management systems in accordance with aspects of the present disclosure.

FIG. 9 illustrates an example of an artificial intelligence (AI) and analytics infrastructure that supports secure blockchain supply management systems in accordance with aspects of the present disclosure.

FIG. 10 illustrates an example of components and boundaries that supports secure blockchain supply management systems in accordance with aspects of the present disclosure.

FIG. 11 shows a block diagram of an apparatus that supports secure blockchain supply management systems in accordance with aspects of the present disclosure.

FIG. 12 shows a block diagram of a blockchain manager that supports secure blockchain supply management systems in accordance with aspects of the present disclosure.

FIG. 13 shows a diagram of a system including a device that supports secure blockchain supply management systems in accordance with aspects of the present disclosure.

FIG. 14 shows a flowchart illustrating methods that support secure blockchain supply management systems in accordance with aspects of the present disclosure.

### DETAILED DESCRIPTION

The described techniques relate to improved methods, systems, devices, and apparatus that support secure blockchain supply management systems. In accordance with aspects of the subject technology, a blockchain centric platform for lifecycle supply chain management (SCM) is disclosed. The subject technology includes an extensive framework of blockchain enable SCM track and trace, total visibility, instantly auditable, trusted distributed ledger technology (DLT). In some aspects, the techniques described herein can enable absolute security, transparency that is tamper-proof, accountability within the SCM structure and asset integrity throughout an entire pipeline, for example, from raw materials, production, shipping, distribution, maintenance and ownership. In some examples, a secure blockchain supply management system and method may provide (i) highly secure system components, and all blockchain replicating nodes, that are accessible to a first predetermined set of one or more entities and (ii) other secure components accessible to a second set of one or more entities and to at least one among the first set of one or more entities.

The techniques described herein uses blockchain cryptographic technologies to identify, store and preclude changes of key transactions. The software and systems may also provide alerts and notifications of any attempts to alter or change the data. Additionally or alternatively, because the information is store in blockchain it can be enhanced by overlaying artificial intelligence (AI) delivering specifics. In some examples, AI delivering specifics may include predicting and anticipating repairs and resupply requirements. In some examples, the “internals” may include rules (e.g., algorithms or business rules) inside the blockchain to perform governance of agreements enforced by smart contracts. In some cases, the blocks may be are secured through consensus.

In some examples, a secure blockchain supply management system may provide an overall blockchain-based service, product, and supply chain management system in which one system-controlling party may own or control use of the overall system and have sole access to certain use of the system and all blockchain replicating nodes, while limited portions of the system may be accessed by others, such as product or service suppliers or users. In some implementations, such a secure blockchain supply management system may provide not only highly secure blockchain data but also allow the system-controlling party to have the sole and highly secure ability to monitor aspects of the blockchain data or use and, if desired, features or use of products or services tracked or provided by the system.

In some examples, a secure blockchain supply management system can provide various tiers of access. For example, a secure blockchain supply management system may include a user-access tier with one level of security and limited access, a services tier with a higher level of security and limited access, and a data-tier with yet a higher level of security and limited access.

Aspects of the disclosure are initially described in the context of a computing environment. Additional aspects of the disclosure are described with reference to various systems corresponding to blockchain nodes, security, authentication, workflows, event and trigger processing, Internet of Things (IoT), AI and analytics infrastructure, as well as components and boundaries. Aspects of the disclosure are further illustrated by and described with reference to apparatus diagrams, system diagrams, and flowcharts that relate to secure blockchain supply management systems.

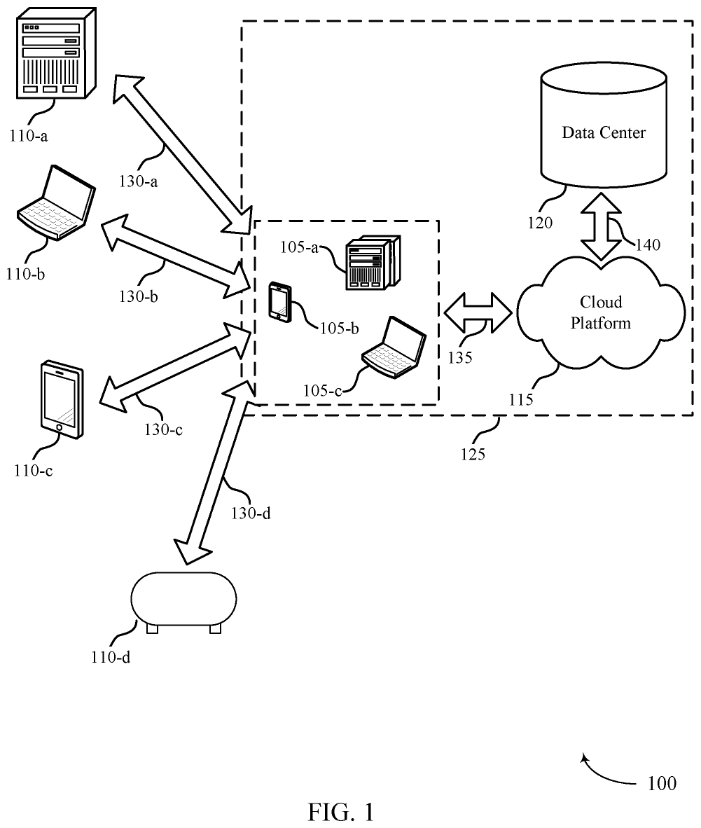

FIG. 1 illustrates an example of a system 100 that supports data processing in a computing environment that supports blockchain supply chain management in accordance with aspects of the present disclosure system. The system 100 may include cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or an IoT sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer a database service to the cloud client 105. In some cases, cloud platform 115 may be an example of a database system. In this case, cloud platform 115 may serve multiple cloud entities or clients 105. However, other types of systems may be implemented, including—but not limited to—client-server systems, mobile device systems, and mobile network systems. In some cases, cloud platform 115 may support SCM and DLT solutions. Cloud platform 115 and associated solutions may include support for contracts, service, analytics, applications, and the IoT. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120. In some cases, the servers may be configured as blockchain nodes in a blockchain database. For example, the data center 120 may include one or more blockchain nodes. A blockchain node may communicate with an IoT sensor (e.g., contact 110-d) operatively coupled to a shipping vehicle.

The system 100 of computing environment described in FIG. 1 as well as other systems in various computing environments may support supports secure blockchain supply management systems such as, for example, a Spitfire™ blockchain system. In some examples, a Spitfire blockchain system may include features such as but not limited to blockchain asset life cycle tracking system, full-control blockchain node deployment, advanced business web ui/ux framework, asset maintenance and workflow service, blockchain identity privacy credential tokens, robust, private permissioned blockchain technology, and integrated, private, secure chat systems. In some examples, a Spitfire blockchain system may interface with other systems for inspection status, shipping/delivering to various locations, shipper information, shipping/delivering post information, OPS/maintenance status, end of life information, acquisitions, acquisitions, and vendor build status.

In accordance with various implementations, Spitfire blockchain systems may be used in various applications. For example, a Spitfire blockchain electronic health record (EHR) metadata asset life-cycle system systems may be utilized in conjunction with EHR systems, HL7 data messaging systems, and high-resolution digital map server systems. In some examples, a Spitfire identity privacy blockchain system may be utilized in conjunction with RemoteMD Wrap Occupational Health Portal systems and medical data record systems. In some examples, a Spitfire incident privacy blockchain system may be utilized in conjunction with privacy and data protection systems, medical data analytics systems, and medical data reporting systems.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

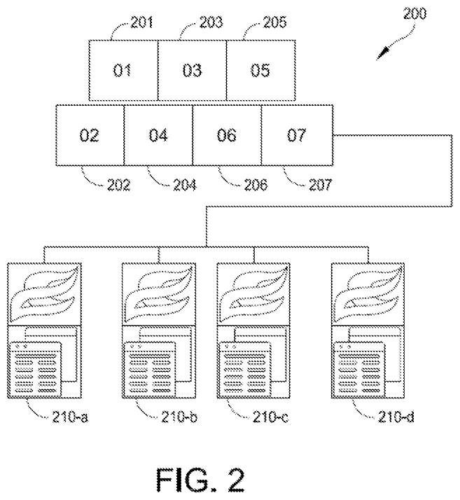

FIG. 2 illustrates an example 200 of blockchain nodes in a blockchain database that supports secure blockchain supply management systems in accordance with aspects of the present disclosure. At 201, a contract may be loaded to a Spitfire blockchain rules engine in one or more of blockchain nodes 210-a, 210-b, 210-c, 210-d. At 203, a blockchain node (e.g., one of blockchain nodes 210-a, 210-b, 210-c, 210-d) may invoke a blockchain transaction associated with the contract document. The invocating may be based at least in part on the loading of the document to the Spitfire blockchain rules engine. At 205, the blockchain node (e.g., one of blockchain nodes 210-a, 210-b, 210-c, 210-d) may determine an ordered block of one or more other transactions based at least in part on the invoking of the blockchain transaction associated with the contract document.

At 202, a blockchain node (e.g., one of blockchain nodes 210-a, 210-b, 210-c, 210-d) may provide the blockchain transaction associated with the contract document based at least in part on the ordered block of the one or more other transactions. The blockchain node (e.g., one of blockchain nodes 210-a, 210-b, 210-c, 210-d) may authorize the blockchain transaction associated with the contract document based at least in part on one or more blockchain policies. The blockchain node (e.g., one of blockchain nodes 210-a, 210-b, 210-c, 210-d) may then install the blockchain transaction associated with the contract document based at least in part on the authorizing.

At 205, the blockchain node (e.g., one of blockchain nodes 210-a, 210-b, 210-c, 210-d) may receive an endorsement of the blockchain transaction associated with the contract document based at least in part on an evaluation from one or more blockchain nodes 210-a, 210-b, 210-c, 210-d that constitute the participating nodes. At 206, the blockchain node (e.g., one of blockchain nodes 210-a, 210-b, 210-c, 210-d) may save the blockchain transaction based at least in part on the endorsement. In some cases, a transaction ordering for a plurality of events and data corresponding to the blockchain transaction associated with the contract document may be saved to each blockchain node 210-a, 210-b, 210-c, 210-d. Based on blockchain nodes 210-a, 210-b, 210-c, 210-d saving the transaction ordering for the plurality of events and data, a distributed ledger may be formed. In this manner, blockchain consensus may be achieved through an intricate endorsement process and saving an exact transaction ordering for events and data cross all node participants.

In some cases, the blockchain node (e.g., one of blockchain nodes 210-a, 210-b, 210-c, 210-d) may receive a rejection of the blockchain transaction associated with the contract document based at least in part on an evaluation from one or more one or more blockchain nodes 210-a, 210-b, 210-c, 210-d that constitute the participating nodes. One or more of the blockchain nodes 210-a, 210-b, 210-c, 210-d may then discard the blockchain transaction based at least in part on the rejection.

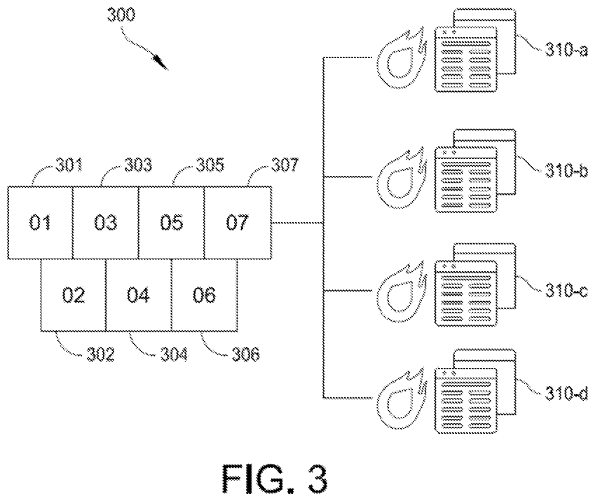

FIG. 3 illustrates an example 300 of blockchain nodes in a blockchain database that supports secure blockchain supply management systems in accordance with aspects of the present disclosure. It is to be appreciated that the example 300 of blockchain nodes 310-a, 310-b, 310-c, 310-d may be implemented architecture themes such as, but not limited to immutable data-centric (e.g., blockchain technologies), well established security compliance, supply chain track-and-trace events, cloud infrastructure, microservices, and ‘baked-in’ security architecture. Additionally, a Spitfire blockchain system may include GMI supply chain re-usable software framework sub-systems including but not limited to advanced business web UI/UX framework, OpenMapTile high-resolution secured digital map server, asset maintenance service, asset management database asset inspection service, asset Life-Cycle API, Tableau analytics and report system, integrated, private, secure chat system, asset event processor, rule workflow processor, blockchain asset life-cycle tracking system, cloud secured cloud scalable API gateway, secured event queue receiver (e.g., QR codes), GPS coordinates, IoT, user identity management (e.g., single sign-on), cyber security components, user authorization, and policy server.

In some examples, a Spitfire blockchain system may include GMI Blockchain may using Hyperledger Fabric v2. At 301, a smart contract may be loaded to Spitfire blockchain rules engine in blockchain nodes 310-a, 310-b, 310-c, 310-d. At 302, blockchain policy may authorize smart contract. The smart contract may be installed on blockchain nodes 310-a, 310-b, 310-c, 310-d. At 303, a spitfire transaction (Tx) invokes the blockchain. At 304, blockchain nodes 310-a, 310-b, 310-c, 310-d may evaluate the smart contract for the Tx. The blockchain nodes 310-a, 310-b, 310-c, 310-d may endorse or approve the Tx. At 305, the Tx may be added to an ordered block of other transactions. At 306, the transaction block may be saved in each ledger of the nodes in the block chain. At 307, a distributed ledger may be formed. Each blockchain node 310-a, 310-b, 310-c, 310-d may have an identical copy of the transaction in exact order. In this manner, each Spitfire Node (e.g., blockchain nodes 310-a, 310-b, 310-c, 310-d) may form the distributed ledger, exactly contains the saved ordered transactions. That is, Spitfire blockchain consensus is achieved through an intricate endorsement process and saving an exact transaction ordering for events and data cross all node participants.

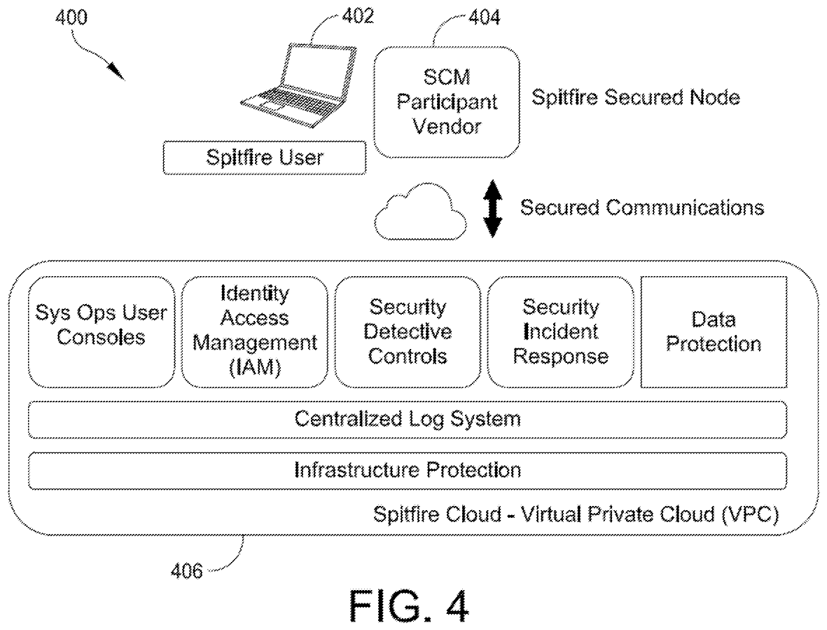

FIG. 4 illustrates an example 400 of security in a cloud platform that supports secure blockchain supply management systems in accordance with aspects of the present disclosure. In some aspects, security in the cloud may be achieved by a shared responsibility model. For example, AWS or Azure may be a cloud provider that operates and secures host operating system layers, reusable common services, and virtual infrastructure. A Spitfire blockchain system may control access and secures data, identities, applications, and any infrastructure controls available from the cloud service. The Spitfire blockchain system may also control all application code and configuration, including sample code provided.

In some implementations, a Spitfire blockchain system may include GMI software architecture themes such as, but not limited to: Security Cloud Architecture (e.g., blockchain cryptography, comprehensive cyber security controls, strong user identity management, data Encryption at rest, encryption in motion, infrastructure cloud cyber security); supply chain track-and-trace (e.g., standard secured messages (GS1, EDI, Barcode), non-standard, secured messages (IoT)); big data management centric (e.g., content management (3V's), data quality, data traceability and change capture); n-Tier Cloud Architecture (e.g., presentation tier: scalable, web/https interfaces), logic tier: microservices architecture, stateless, serverless nodes, data tier: strong system-of-record (SR): blockchain, support for structured and unstructured, rich query, ETL, and analytics) flexible data warehousing (e.g., data virtualization across sources and events (GS1, EDI), data dimensioning, query reporting, analytics processing); and cloud infrastructure (e.g., scalability, stateless, serverless, virtual machine, docker container management, SysOps tools for management center).

In accordance with some aspects, a Spitfire blockchain system may include novel features such as, but not limited to, operating multiple blockchain nodes all owned and controlled by a customer. For example, Spitfire blockchain nodes evaluate all transactions based on the encoded customer's operating rules within their secured, controlled cyber environment. Master crypto-key and data encryption controls may be employed for secured and accurate on-boarding, managing participants, and for controlling permissions for ledger data content. Chaincode inference engine, forward-chaining rule-engine features in which the automated decision-making consensus are performed by the unique, programmed Spitfire rules that form the smart contract. Direct in-chain AI and analytics processing, forward-, backward-chaining rule inferencing may be employed for triggering system operations such as digital signatures, notifications, data transfers, and milestone completions. In some cases, managed cloud deployment may be included where nodes can be securely distributed to different machines using the most advanced cloud container technologies operating in different secured, network zones. Separated and secured transaction ordering may be provided for consensus. In some examples, each node may provide its own separate, secured ordering service for increased performance and robustness better than centrally shared. Secured, isolated privacy storage may prevent all members in a group from seeing private data for individuals in that same group.

In some examples, a Spitfire cloud 406 may be accessible to a Spitfire user 402, via a Spitfire secured node 404. Spitfire secured node 404 may use secured communications to communication with be Spitfire cloud 406. In some cases, security in the cloud may include practices that may be ‘baked in’ the architecture from the start. Non limiting examples of the practices include identity and access management, detective controls, infrastructure protection, data protection, and incident response.

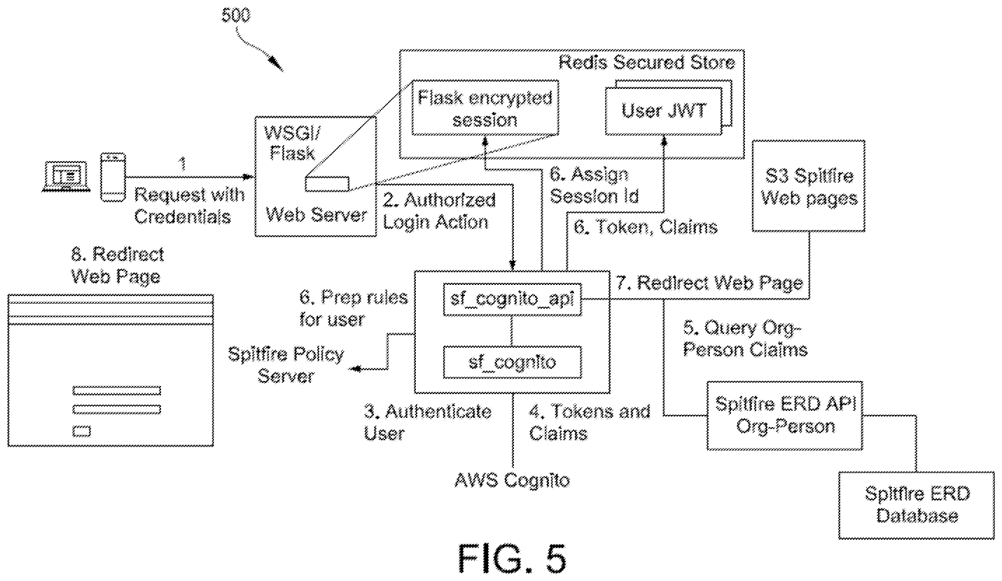

FIG. 5 illustrates an example 500 of authentication process that supports secure blockchain supply management systems in accordance with aspects of the present disclosure. In one example, a Spitfire authentication process may include: 1. user authenticates with Spitfire by providing username and password; 2. Spitfire authorizes the login action through permission processing with the Spitfire policy server; 3. the username is authenticated with the AWS Cognito sub-system; 4. AWS Cognito produces the User AccessId and bearer tokens—additional user data called Claims may be provided; 5. the username is further verified in the Spitfire application database—this may provide for the data permission authorizations: 6. the user's tokens and tracking SessionId are stored in the secured store, an in-memory only cache (e.g., the policy server is primed for the user role rules; 7. the next web page is redirected to the user's browser; and 8. the Spitfire landing Web Page is displayed for to the authorized user.

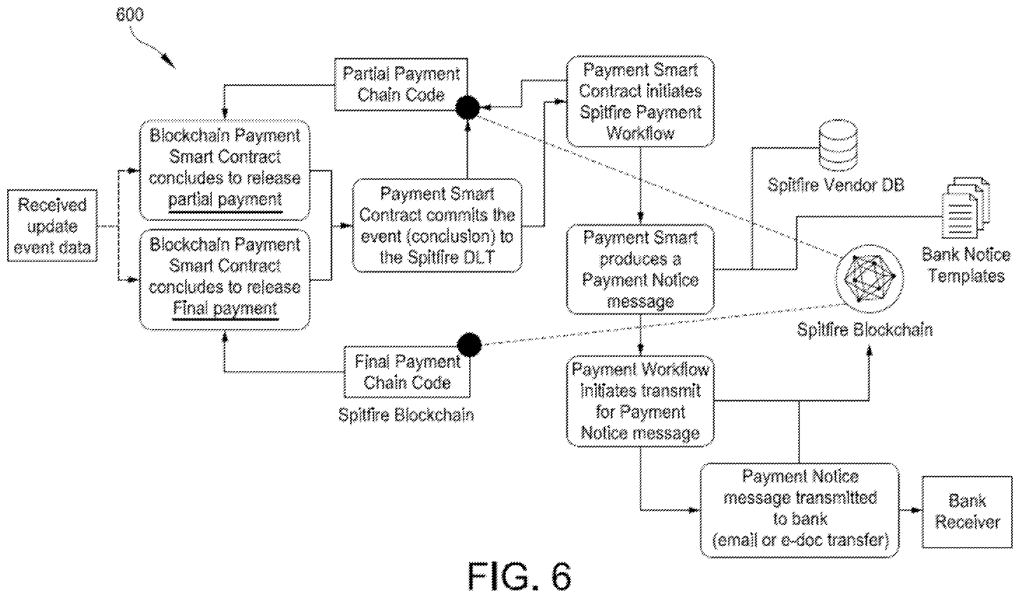

FIG. 6 illustrates an example 600 of a smart contract workflow that supports secure blockchain supply management systems in accordance with aspects of the present disclosure. In the example 600 of FIG. 6, the Spitfire blockchain system provides workflow notice for financial and banking transactions based on receipt of transaction-related event data.

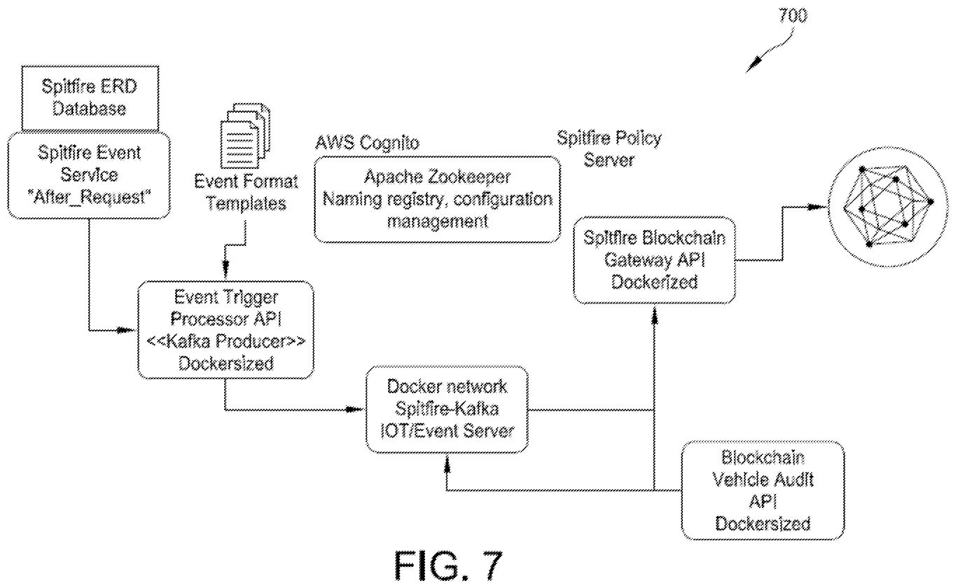

FIG. 7 illustrates an example 700 of event and trigger processing that supports secure blockchain supply management systems in accordance with aspects of the present disclosure. In the example 700 of FIG. 7, an explanation of various event and trigger processing techniques that can be provided by the Spitfire Blockchain system is provided.

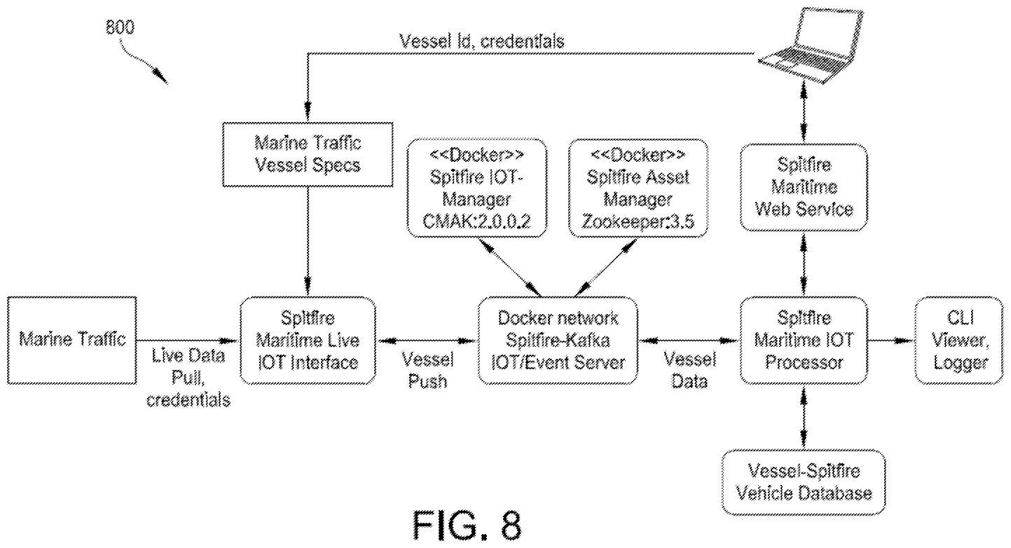

FIG. 8 illustrates an example 800 of an IoT system that supports secure blockchain supply management systems in accordance with aspects of the present disclosure. In the example 800 of FIG. 8, use of an IoT implementation the Spitfire blockchain system to manage maritime traffic is provided.

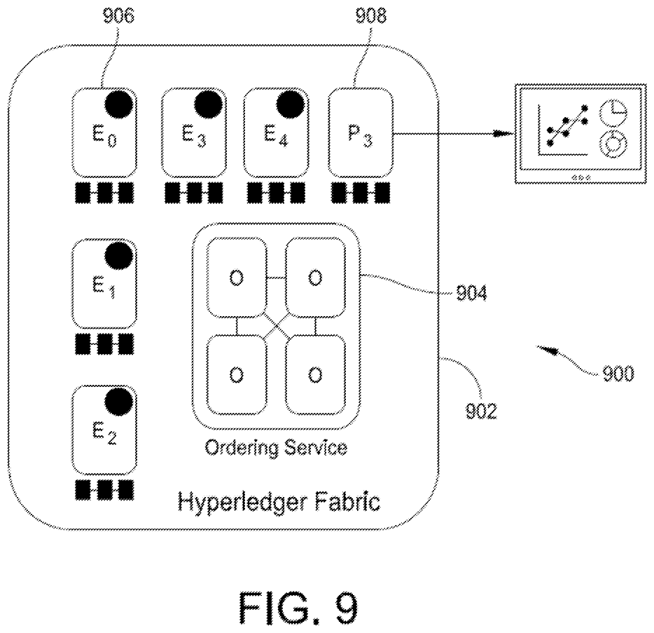

FIG. 9 illustrates an example 900 of an AI and analytics infrastructure that supports secure blockchain supply management systems in accordance with aspects of the present disclosure. As shown in the example 900 of FIG. 9, the Spitfire Blockchain system can be structured and used to implement business rules, AI, and analytics. In some examples, hyperledger fabric 902 may be utilized in automated decision-making (e.g., endorsements) that may be performed by chaincode based on the novel Spitfire operating rules. Hyperledger fabric 902 may include an ordering service 904, one or more endorsing nodes 906, and a processing node 908.

For consensus, chaincode inference engine, forward-chaining rule-engine may be employed in one or more endorsing nodes 906. Processing node 908 may include direct in-chain AI and analytics processing, backward-chaining inferencing. In some cases, off-chain AI and analytics may be included in example 900.

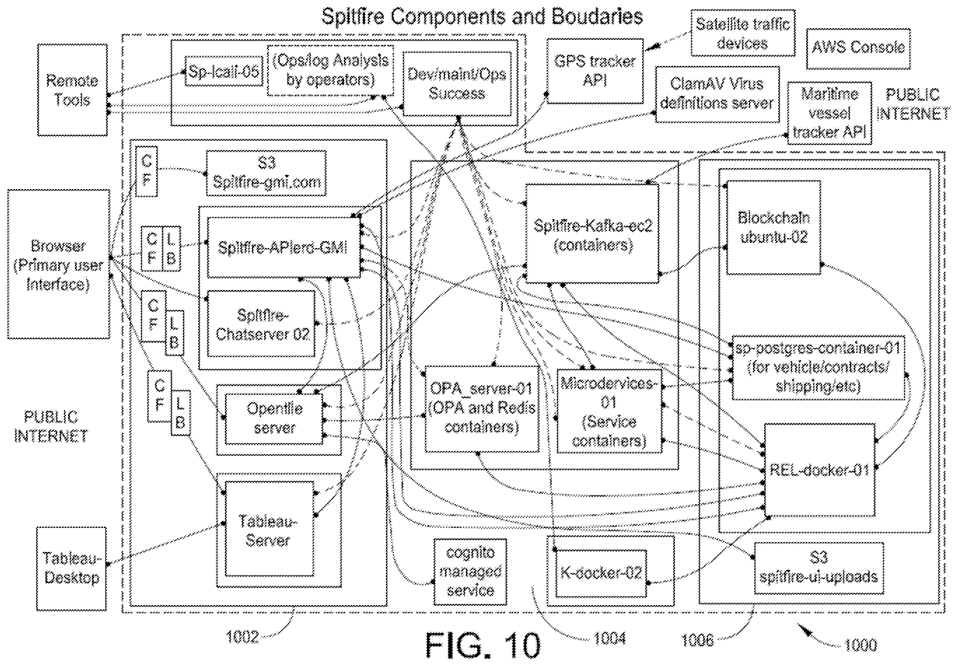

FIG. 10 illustrates an example 1000 of components and boundaries that supports secure blockchain supply management systems in accordance with aspects of the present disclosure. As shown in the example 1000 of FIG. 10, a Spitfire Blockchain system can have a User-access tier, a more restricted Services Tier, and an even more restricted Data Tier. In the User-access tier, network access to this tier from the public internet is constrained as much as possible to predefined users/systems/IP addresses/etc., via whitelisting, user/browser private keys, etc.

In some examples, a user-access tier 1002 may include network access from public internet ideally constrained as much as possible to be predefined users/systems/Ps/etc. via whitelisting, user/browser private key, etc. A services tier 1004 may include features in which no network access from or to public internet except during development by strict exception during updates, etc. and then constrained as much as possible to predefined users/systems/Ps/etc. via whitelisting, user private key, etc. Also, ideally no internet gateway on subnets. Maintenance access only by whitelisted local IP, port, Security group (admin subnet). A data tier 1006 may include highly protected database servers. For example, no network access from or to public internet is allowed; no internet groups and allowed. Operational access by other tiers may be strictly whitelisted at high resolution. Maintenance access may only be accessed by whitelisted local IP, port, Security group (e.g., admin subnet).

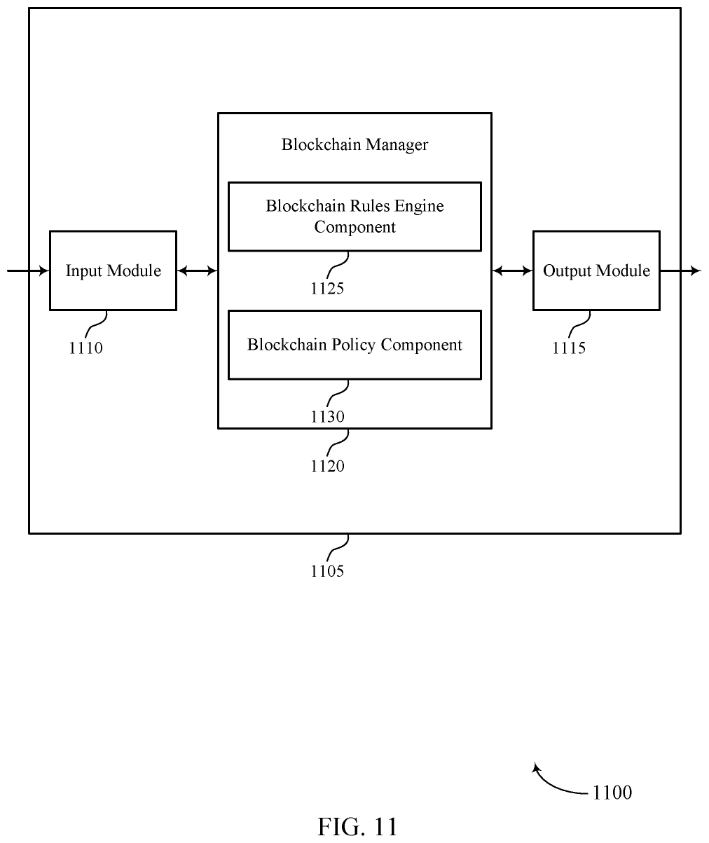

FIG. 11 shows a block diagram 1100 of a device 1105 that supports secure blockchain supply management system in accordance with aspects of the present disclosure. The device 1105 may include an input module 1110, an output module 1115, and a blockchain manager 1120. The device 1105 may also include a processor. Each of these components may be in communication with one another (e.g., via one or more buses).

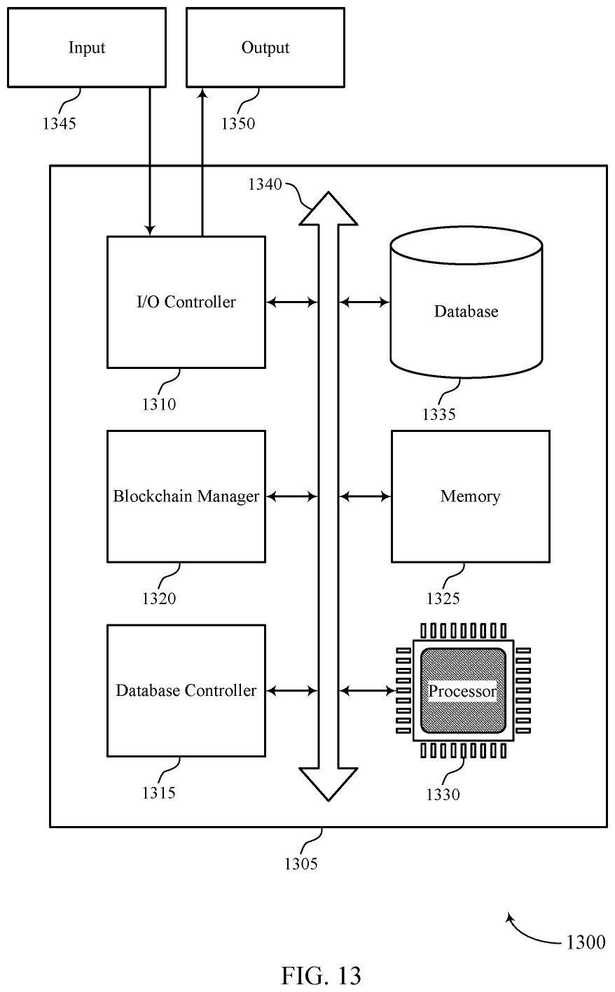

The input module 1110 may manage input signals for the device 1105. For example, the input module 1110 may identify input signals based on an interaction with a modem, a keyboard, a mouse, a touchscreen, or a similar device. These input signals may be associated with user input or processing at other components or devices. In some cases, the input module 1110 may utilize an operating system such as iOS®, ANDROID®, MS-DOS®, MS-WINDOWS®, OS/2®, UNIX®, LINUX®, or another known operating system to handle input signals. The input module 1110 may send aspects of these input signals to other components of the device 1105 for processing. For example, the input module 1110 may transmit input signals to the {PRIMARY MODULE} 1120 to support secure blockchain supply management system. In some cases, the input module 1110 may be a component of an I/O controller 1310 as described with reference to FIG. 13.

The output module 1115 may manage output signals for the device 1105. For example, the output module 1115 may receive signals from other components of the device 1105, such as the blockchain manager 1120, and may transmit these signals to other components or devices. In some examples, the output module 1115 may transmit output signals for display in a user interface, for storage in a database or data store, for further processing at a server or server cluster, or for any other processes at any number of devices or systems. In some cases, the output module 1115 may be a component of an I/O controller 1310 as described with reference to FIG. 13.

For example, the blockchain manager 1120 may include a blockchain rules engine component 1125 a blockchain policy component 1130, or any combination thereof. In some examples, the blockchain manager 1120, or various components thereof, may be configured to perform various operations (e.g., receiving, monitoring, transmitting) using or otherwise in cooperation with the input module 1110, the output module 1115, or both. For example, the blockchain manager 1120 may receive information from the input module 1110, send information to the output module 1115, or be integrated in combination with the input module 1110, the output module 1115, or both to receive information, transmit information, or perform various other operations as described herein.

The blockchain manager 1120 may support blockchain supply chain management in accordance with examples as disclosed herein. The blockchain rules engine component 1125 may be configured as or otherwise support a means for loading a contract to a blockchain rules engine. The blockchain rules engine component 1125 may be configured as or otherwise support a means for invoking a blockchain transaction associated with the contract document based on the loading. The blockchain rules engine component 1125 may be configured as or otherwise support a means for determining an ordered block of one or more other transactions based on the invoking. The blockchain policy component 1130 may be configured as or otherwise support a means for providing the blockchain transaction associated with the contract document based on the ordered block of the one or more other transactions. The blockchain policy component 1130 may be configured as or otherwise support a means for authorizing the blockchain transaction associated with the contract document based on one or more blockchain policies. The blockchain policy component 1130 may be configured as or otherwise support a means for installing the blockchain transaction associated with the contract document based on the authorizing.

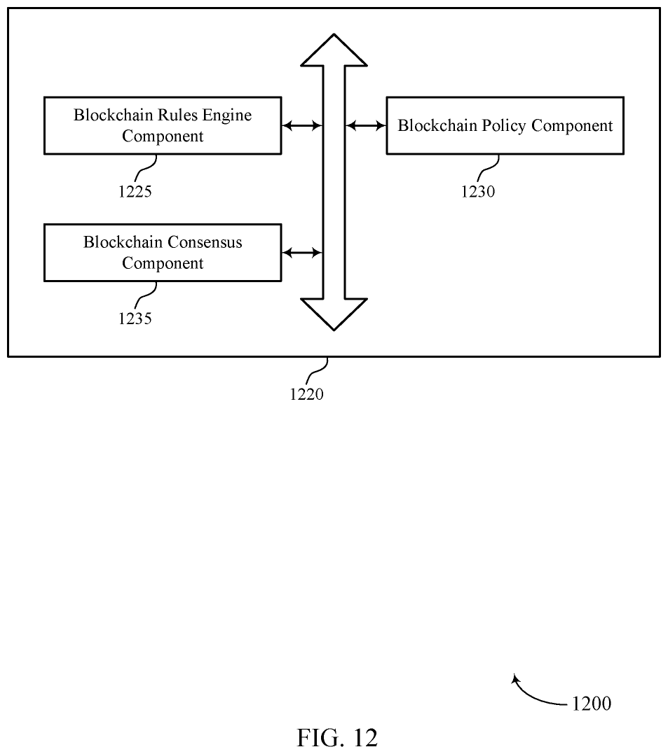

FIG. 12 shows a block diagram 1200 of a blockchain manager 1220 that supports secure blockchain supply management system in accordance with aspects of the present disclosure. The blockchain manager 1220 may be an example of aspects of a blockchain manager or a blockchain manager 1120, or both, as described herein. The blockchain manager 1220, or various components thereof, may be an example of means for performing various aspects of secure blockchain supply management system as described herein. For example, the blockchain manager 1220 may include a blockchain rules engine component 1225, a blockchain policy component 1230, a blockchain consensus component 1235, or any combination thereof. Each of these components may communicate, directly or indirectly, with one another (e.g., via one or more buses).

The blockchain manager 1220 may support blockchain supply chain management in accordance with examples as disclosed herein. The blockchain rules engine component 1225 may be configured as or otherwise support a means for loading a contract to a blockchain rules engine. In some examples, the blockchain rules engine component 1225 may be configured as or otherwise support a means for invoking a blockchain transaction associated with the contract document based on the loading. In some examples, the blockchain rules engine component 1225 may be configured as or otherwise support a means for determining an ordered block of one or more other transactions based on the invoking. The blockchain policy component 1230 may be configured as or otherwise support a means for providing the blockchain transaction associated with the contract document based on the ordered block of the one or more other transactions. In some examples, the blockchain policy component 1230 may be configured as or otherwise support a means for authorizing the blockchain transaction associated with the contract document based on one or more blockchain policies. In some examples, the blockchain policy component 1230 may be configured as or otherwise support a means for installing the blockchain transaction associated with the contract document based on the authorizing.

In some examples, the blockchain consensus component 1235 may be configured as or otherwise support a means for receiving an endorsement of the blockchain transaction associated with the contract document based on an evaluation from one or more nodes of a set of multiple participating nodes. In some examples, the blockchain consensus component 1235 may be configured as or otherwise support a means for saving the blockchain transaction based on the endorsement.

In some examples, to support saving the blockchain transaction, the blockchain consensus component 1235 may be configured as or otherwise support a means for saving a transaction ordering for a set of multiple events and data corresponding to the blockchain transaction associated with the contract document to each node of the set of multiple participating nodes.

In some examples, the blockchain consensus component 1235 may be configured as or otherwise support a means for forming a distributed ledger based on the saving the transaction ordering for the set of multiple events and data.

In some examples, the blockchain consensus component 1235 may be configured as or otherwise support a means for receiving a rejection of the blockchain transaction associated with the contract document based on an evaluation from one or more nodes of a set of multiple participating nodes. In some examples, the blockchain consensus component 1235 may be configured as or otherwise support a means for discarding the blockchain transaction based on the rejection.

FIG. 13 shows a diagram of a system 1300 including a device 1305 that supports secure blockchain supply management system in accordance with aspects of the present disclosure. The device 1305 may be an example of or include the components of a device 1105 as described herein. The device 1305 may include components for bi-directional data communications including components for transmitting and receiving communications, such as a blockchain manager 1320, an I/O controller 1310, a database controller 1315, a memory 1325, a processor 1330, and a database 1335. These components may be in electronic communication or otherwise coupled (e.g., operatively, communicatively, functionally, electronically, electrically) via one or more buses (e.g., a bus 1340).

The I/O controller 1310 may manage input signals 1345 and output signals 1350 for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. In other cases, the I/O controller 1310 may represent or interact with a modem, a keyboard, a mouse, a touchscreen, or a similar device. In some cases, the I/O controller 1310 may be implemented as part of a processor 1330. In some examples, a user may interact with the device 1305 via the I/O controller 1310 or via hardware components controlled by the I/O controller 1310.

The database controller 1315 may manage data storage and processing in a database 1335. In some cases, a user may interact with the database controller 1315. In other cases, the database controller 1315 may operate automatically without user interaction. The database 1335 may be an example of a single database, a distributed database, multiple distributed databases, a data store, a data lake, or an emergency backup database.

Memory 1325 may include random-access memory (RAM) and ROM. The memory 1325 may store computer-readable, computer-executable software including instructions that, when executed, cause the processor 1330 to perform various functions described herein. In some cases, the memory 1325 may contain, among other things, a BIOS which may control basic hardware or software operation such as the interaction with peripheral components or devices.

The processor 1330 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1330 may be configured to operate a memory array using a memory controller. In other cases, a memory controller may be integrated into the processor 1330. The processor 1330 may be configured to execute computer-readable instructions stored in a memory 1325 to perform various functions (e.g., functions or tasks supporting secure blockchain supply management system).

The blockchain manager 1320 may support blockchain supply chain management in accordance with examples as disclosed herein. For example, the blockchain manager 1320 may be configured as or otherwise support a means for loading a contract to a blockchain rules engine. The blockchain manager 1320 may be configured as or otherwise support a means for invoking a blockchain transaction associated with the contract document based on the loading. The blockchain manager 1320 may be configured as or otherwise support a means for determining an ordered block of one or more other transactions based on the invoking. The blockchain manager 1320 may be configured as or otherwise support a means for providing the blockchain transaction associated with the contract document based on the ordered block of the one or more other transactions. The blockchain manager 1320 may be configured as or otherwise support a means for authorizing the blockchain transaction associated with the contract document based on one or more blockchain policies. The blockchain manager 1320 may be configured as or otherwise support a means for installing the blockchain transaction associated with the contract document based on the authorizing.

By including or configuring the blockchain manager 1320 in accordance with examples as described herein, the device 1305 may support techniques for secure blockchain supply management.

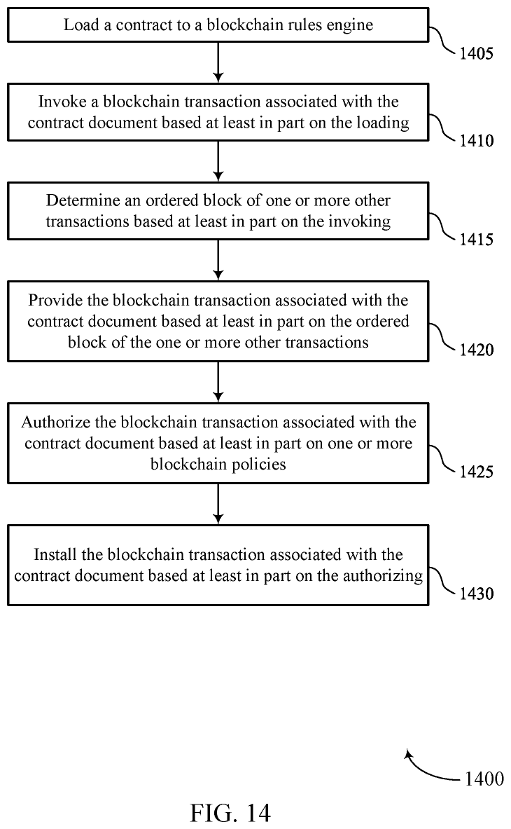

FIG. 14 shows a flowchart illustrating a method 1400 that supports secure blockchain supply management system in accordance with aspects of the present disclosure. The operations of the method 1400 may be implemented by a blockchain node or its components as described herein. For example, the operations of the method 1400 may be performed by a blockchain node as described with reference to FIGS. 1 through 13. In some examples, a blockchain node may execute a set of instructions to control the functional elements of the blockchain node to perform the described functions. Additionally, or alternatively, the blockchain node may perform aspects of the described functions using special-purpose hardware.

At 1405, the method may include loading a contract to a blockchain rules engine. The operations of 1405 may be performed in accordance with examples as disclosed herein. In some examples, aspects of the operations of 1405 may be performed by a blockchain rules engine component 1225 as described with reference to FIG. 12.

At 1410, the method may include invoking a blockchain transaction associated with the contract document based on the loading. The operations of 1410 may be performed in accordance with examples as disclosed herein. In some examples, aspects of the operations of 1410 may be performed by a blockchain rules engine component 1225 as described with reference to FIG. 12.

At 1415, the method may include determining an ordered block of one or more other transactions based on the invoking. The operations of 1415 may be performed in accordance with examples as disclosed herein. In some examples, aspects of the operations of 1415 may be performed by a blockchain rules engine component 1225 as described with reference to FIG. 12.

At 1420, the method may include providing the blockchain transaction associated with the contract document based on the ordered block of the one or more other transactions. The operations of 1420 may be performed in accordance with examples as disclosed herein. In some examples, aspects of the operations of 1420 may be performed by a blockchain policy component 1230 as described with reference to FIG. 12.

At 1425, the method may include authorizing the blockchain transaction associated with the contract document based on one or more blockchain policies. The operations of 1425 may be performed in accordance with examples as disclosed herein. In some examples, aspects of the operations of 1425 may be performed by a blockchain policy component 1230 as described with reference to FIG. 12.

At 1430, the method may include installing the blockchain transaction associated with the contract document based on the authorizing. The operations of 1430 may be performed in accordance with examples as disclosed herein. In some examples, aspects of the operations of 1430 may be performed by a blockchain policy component 1230 as described with reference to FIG. 12.

In some examples, a method for blockchain supply chain management is described. The method may include loading a contract to a blockchain rules engine, invoking a blockchain transaction associated with the contract document based on the loading, determining an ordered block of one or more other transactions based on the invoking, providing the blockchain transaction associated with the contract document based on the ordered block of the one or more other transactions, authorizing the blockchain transaction associated with the contract document based on one or more blockchain policies, and installing the blockchain transaction associated with the contract document based on the authorizing.

In some examples, an apparatus for blockchain supply chain management is described. The apparatus may include a processor, memory coupled with the processor, and instructions stored in the memory. The instructions may be executable by the processor to cause the apparatus to load a contract to a blockchain rules engine, invoke a blockchain transaction associated with the contract document based on the loading, determine an ordered block of one or more other transactions based on the invoking, provide the blockchain transaction associated with the contract document based on the ordered block of the one or more other transactions, authorize the blockchain transaction associated with the contract document based on one or more blockchain policies, and install the blockchain transaction associated with the contract document based on the authorizing.

In some examples, another apparatus for blockchain supply chain management is described. The apparatus may include means for loading a contract to a blockchain rules engine, means for invoking a blockchain transaction associated with the contract document based on the loading, means for determining an ordered block of one or more other transactions based on the invoking, means for providing the blockchain transaction associated with the contract document based on the ordered block of the one or more other transactions, means for authorizing the blockchain transaction associated with the contract document based on one or more blockchain policies, and means for installing the blockchain transaction associated with the contract document based on the authorizing.

In some examples, a non-transitory computer-readable medium storing code for blockchain supply chain management is described. The code may include instructions executable by a processor to load a contract to a blockchain rules engine, invoke a blockchain transaction associated with the contract document based on the loading, determine an ordered block of one or more other transactions based on the invoking, provide the blockchain transaction associated with the contract document based on the ordered block of the one or more other transactions, authorize the blockchain transaction associated with the contract document based on one or more blockchain policies, and install the blockchain transaction associated with the contract document based on the authorizing.

Some examples of the method, apparatuses, and non-transitory computer-readable medium described herein may further include operations, features, means, or instructions for receiving an endorsement of the blockchain transaction associated with the contract document based on an evaluation from one or more nodes of a set of multiple participating nodes and saving the blockchain transaction based on the endorsement.

In some examples of the method, apparatuses, and non-transitory computer-readable medium described herein, saving the blockchain transaction may include operations, features, means, or instructions for saving a transaction ordering for a set of multiple events and data corresponding to the blockchain transaction associated with the contract document to each node of the set of multiple participating nodes.

Some examples of the method, apparatuses, and non-transitory computer-readable medium described herein may further include operations, features, means, or instructions for forming a distributed ledger based on the saving the transaction ordering for the set of multiple events and data.

Some examples of the method, apparatuses, and non-transitory computer-readable medium described herein may further include operations, features, means, or instructions for receiving a rejection of the blockchain transaction associated with the contract document based on an evaluation from one or more nodes of a set of multiple participating nodes and discarding the blockchain transaction based on the rejection.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for blockchain supply chain management, comprising:
a processor;
memory coupled with the processor; and
instructions stored in the memory and executable by the processor to cause the apparatus to:
load a contract to a blockchain rules engine;
invoke a blockchain transaction associated with the contract document based at least in part on the loading;
determine an ordered block of one or more other transactions based at least in part on the invoking;
provide the blockchain transaction associated with the contract document based at least in part on the ordered block of the one or more other transactions;
authorize the blockchain transaction associated with the contract document based at least in part on one or more blockchain policies; and
install the blockchain transaction associated with the contract document based at least in part on the authorizing.

2. The apparatus of claim 1, wherein the instructions are further executable by the processor to cause the apparatus to:
receive an endorsement of the blockchain transaction associated with the contract document based at least in part on an evaluation from one or more nodes of a plurality of participating nodes; and
save the blockchain transaction based at least in part on the endorsement.

3. The apparatus of claim 2, wherein the instructions to save the blockchain transaction are executable by the processor to cause the apparatus to:
save a transaction ordering for a plurality of events and data corresponding to the blockchain transaction associated with the contract document to each node of the plurality of participating nodes.

4. The apparatus of claim 3, wherein the instructions are further executable by the processor to cause the apparatus to:
form a distributed ledger based at least in part on the saving the transaction ordering for the plurality of events and data

5. The apparatus of claim 1, wherein the instructions are further executable by the processor to cause the apparatus to:
receive a rejection of the blockchain transaction associated with the contract document based at least in part on an evaluation from one or more nodes of a plurality of participating nodes; and
discard the blockchain transaction based at least in part on the rejection.

6. An apparatus for blockchain supply chain management, comprising:
means for loading a contract to a blockchain rules engine;
means for invoking a blockchain transaction associated with the contract document based at least in part on the loading;
means for determining an ordered block of one or more other transactions based at least in part on the invoking;
means for providing the blockchain transaction associated with the contract document based at least in part on the ordered block of the one or more other transactions;
means for authorizing the blockchain transaction associated with the contract document based at least in part on one or more blockchain policies; and
means for installing the blockchain transaction associated with the contract document based at least in part on the authorizing.

7. The apparatus of claim 6, further comprising:
means for receiving an endorsement of the blockchain transaction associated with the contract document based at least in part on an evaluation from one or more nodes of a plurality of participating nodes; and
means for saving the blockchain transaction based at least in part on the endorsement.

8. The apparatus of claim 7, wherein the means for saving the blockchain transaction comprise:
means for saving a transaction ordering for a plurality of events and data corresponding to the blockchain transaction associated with the contract document to each node of the plurality of participating nodes.

9. The apparatus of claim 8, further comprising:
means for forming a distributed ledger based at least in part on the saving the transaction ordering for the plurality of events and data

10. The apparatus of claim 6, further comprising:
means for receiving a rejection of the blockchain transaction associated with the contract document based at least in part on an evaluation from one or more nodes of a plurality of participating nodes; and
means for discarding the blockchain transaction based at least in part on the rejection.

11. A non-transitory computer-readable medium storing code for blockchain supply chain management, the code comprising instructions executable by a processor to:
load a contract to a blockchain rules engine;
invoke a blockchain transaction associated with the contract document based at least in part on the loading;
determine an ordered block of one or more other transactions based at least in part on the invoking;
provide the blockchain transaction associated with the contract document based at least in part on the ordered block of the one or more other transactions;
authorize the blockchain transaction associated with the contract document based at least in part on one or more blockchain policies; and
install the blockchain transaction associated with the contract document based at least in part on the authorizing.

12. The non-transitory computer-readable medium of claim 11, wherein the instructions are further executable by the processor to:
receive an endorsement of the blockchain transaction associated with the contract document based at least in part on an evaluation from one or more nodes of a plurality of participating nodes; and
save the blockchain transaction based at least in part on the endorsement.

13. The non-transitory computer-readable medium of claim 12, wherein the instructions to save the blockchain transaction are executable by the processor to:
save a transaction ordering for a plurality of events and data corresponding to the blockchain transaction associated with the contract document to each node of the plurality of participating nodes.

14. The non-transitory computer-readable medium of claim 13, wherein the instructions are further executable by the processor to:
form a distributed ledger based at least in part on the saving the transaction ordering for the plurality of events and data

15. The non-transitory computer-readable medium of claim 11, wherein the instructions are further executable by the processor to:
receive a rejection of the blockchain transaction associated with the contract document based at least in part on an evaluation from one or more nodes of a plurality of participating nodes; and
discard the blockchain transaction based at least in part on the rejection.
